(19) United States
(12) Patent Application Publication
(10) Pub. No.: US 2024/0331912 A1
(43) Pub. Date: Oct. 3, 2024

(54) INDUCTOR COMPONENT

(71) Applicant: Murata Manufacturing Co., Ltd., Kyoto-fu (JP)

(72) Inventors: Kiyotaka NISHI, Nagaokakyo-shi (JP); Masaki INUI, Nagaokakyo-shi (JP)

(73) Assignee: Murata Manufacturing Co., Ltd., Kyoto-fu (JP)

(21) Appl. No.: 18/437,842

(22) Filed: Feb. 9, 2024

(30) Foreign Application Priority Data
Mar. 28, 2023 (JP) 2023-052075

(51) Int. Cl. H01F 17/00; H01F 27/32

(52) U.S. Cl. CPC H01F 17/0013; H01F 27/323

(57) ABSTRACT

An inductor component includes an element including insulating layers that are laminated, and a coil in the element and helically wound about an axis. The coil includes a first outer coil wiring layer outermost on a first side in a direction of the axis, a second outer coil wiring layer outermost on a second side in the direction of the axis, and at least one inner coil wiring layer between the first and second outer coil wiring layers. The first outer coil wiring layer, the at least one inner coil wiring layer, and the second outer coil wiring layer are laminated while alternating with the insulating layers. The insulating layer between the first outer coil wiring layer and the inner coil wiring layer adjacent to the first outer coil wiring layer in the direction of the axis has a thickness smaller than or equal to 6.5 μm.

### CROSS-REFERENCE TO RELATED APPLICATION

This application claims benefit of priority to Japanese Patent Application No. 2023-052075, filed Mar. 28, 2023, the entire content of which is incorporated herein by reference.

### BACKGROUND

### Technical Field

The present disclosure relates to an inductor component.

### Background Art

Japanese Unexamined Patent Application Publication No. 2002-246231 describes an example of an inductor component. This inductor component is a coil including extended conductor patterns located at outermost layers, two coil conductor patterns with one or more turns disposed to be in contact with the extended conductor patterns, and multiple coil conductor patterns with less than one turn disposed to be in contact with the coil conductor patterns with one or more turns. The conductor patterns and insulating layers are alternately laminated.

### SUMMARY

In the above known inductor component, the extended conductor patterns located at the outermost layers may cause electrochemical migration. Diligent study on this point has revealed that the extended conductor patterns located at the outermost layers increase direct current resistance, and the field strength that occurs between the outermost layers and the conductor patterns of the layers adjacent to the outermost layers increases during application of current.

Accordingly, the present disclosure provides an inductor component that leads to less occurrence of electrochemical migration.

An inductor component according to an aspect of the present disclosure includes an element including a plurality of insulating layers that are laminated, and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and the first outer coil wiring layer has a direct current resistance smaller than or equal to 0.18Ω.

As described above, when the direct current resistance (hereafter also described as “Rdc”) of the first outer coil wiring layer serving as one of the outermost layers is reduced, the field strength between the first outer coil wiring layer and the first inner coil wiring layer is reduced regardless of when the thickness of the insulating layer between the first outer coil wiring layer and the first inner coil wiring layer is reduced. Reducing the field strength leads to less occurrence of electrochemical migration between the first outer coil wiring layer and the first inner coil wiring layer.

An inductor component according to another embodiment of the present disclosure includes an element including a plurality of insulating layers that are laminated, and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and the first outer coil wiring layer has a line length smaller than or equal to 670 μm.

When Rdc is reduced by reducing the line length of the first outer coil wiring, the field strength between the first outer coil wiring layer and the first inner coil wiring layer is reduced regardless of when the thickness of the insulating layer between the first outer coil wiring layer and the first inner coil wiring layer is reduced. Thus, the inductor component leads to less occurrence of electrochemical migration between the first outer coil wiring layer and the first inner coil wiring layer.

An inductor component according to another embodiment of the present disclosure includes an element, and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and a ratio of a line length of the first outer coil wiring layer to a cross-sectional area of the first outer coil wiring layer is smaller than or equal to 11 μm⁻¹.

When the first outer coil wiring layer has a larger cross-sectional area and a shorter line length, Rdc is reduced. In other words, when the ratio of the line length of the first outer coil wiring layer to the cross-sectional area is reduced, the Rdc is reduced. Thus, the field strength between the first outer coil wiring layer and the first inner coil wiring layer is reduced regardless of when the thickness of the insulating layer between the first outer coil wiring layer and the first inner coil wiring layer is reduced. This structure leads to less occurrence of electrochemical migration between the first outer coil wiring layer and the first inner coil wiring layer.

An inductor component according to another embodiment of the present disclosure includes an element, and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. When a current twice a rated current is applied, a field strength between the first outer coil wiring layer and the inner coil wiring layer adjacent to the first outer coil wiring layer in the direction of the axis is smaller than or equal to 0.040 V/μm.

Reducing the field strength leads to less occurrence of electrochemical migration between the first outer coil wiring layer and the first inner coil wiring layer.

An inductor component according to another embodiment of the present disclosure includes an element, and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The first outer coil wiring layer has less than one turn, and the inner coil wiring layer adjacent to the first outer coil wiring layer in the direction of the axis has one or more turns.

A first outer coil wiring layer 501 with less than one turn can have smaller electric resistance, and the field strength between the first outer coil wiring layer and the first inner coil wiring layer is reduced. This structure leads to less occurrence of electrochemical migration between the first outer coil wiring layer and the first inner coil wiring layer. A first inner coil wiring layer 502 with one or more turns can have improved inductance (L).

An inductor component according to an aspect of the present disclosure is an inductor component that leads to less occurrence of electrochemical migration.

### BRIEF DESCRIPTION OF THE DRAWINGS

FIG. 1 is a perspective view of an inductor component according to a first embodiment;

FIG. 2 is a perspective front view of an inductor component viewed from a first side surface;

FIG. 3 is a YZ cross-sectional view of an inductor component;

FIG. 4A is an exploded plan view of an inductor component;

FIG. 4B is an exploded plan view of an inductor component;

FIG. 4C is an exploded plan view of an inductor component;

FIG. 5 is a graph illustrating the relationship between the field strength and Rdc of a first outer coil wiring layer;

FIG. 6A is an image diagram of an inductor component;

FIG. 6B is an image diagram of an inductor component;

FIG. 6C is an image diagram of an inductor component;

FIG. 7 is a graph illustrating the relationship between the field strength and the line length of a first outer coil wiring layer of an inductor component according to a second embodiment;

FIG. 8 is a graph illustrating the relationship between the field strength and the ratio of line length of a first outer coil wiring layer of an inductor component according to a third embodiment to the cross-sectional area;

FIG. 9 is an exploded plan view of an inductor component according to a sixth embodiment; and

FIG. 10 is a YZ cross-sectional view of an inductor component according to a seventh embodiment.

### DETAILED DESCRIPTION

Hereafter, an inductor component according to an aspect of the present disclosure is more specifically described using embodiments illustrated in the drawings. The drawings may include a schematic diagram, and may fail to have the actual dimensions or ratios to be reflected thereon.

### First Embodiment

### Entire Structure of Inductor Component 1

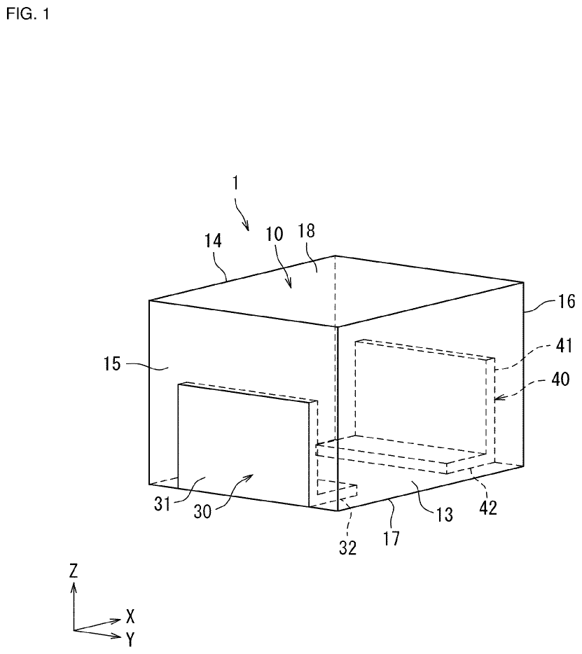

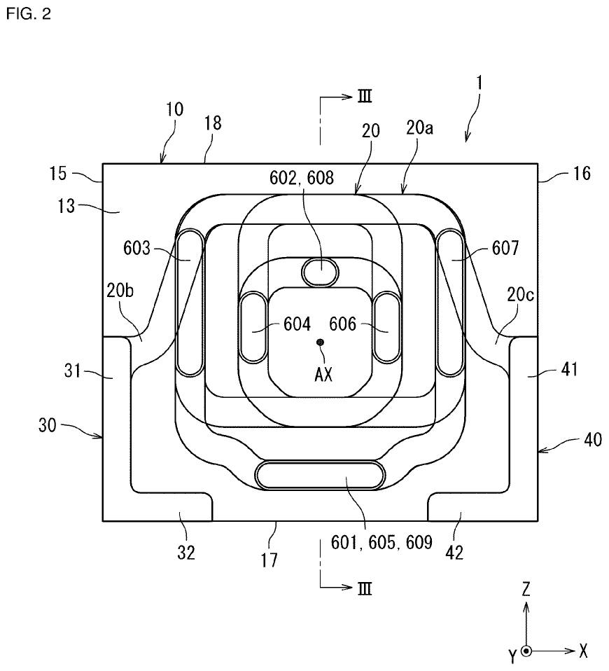

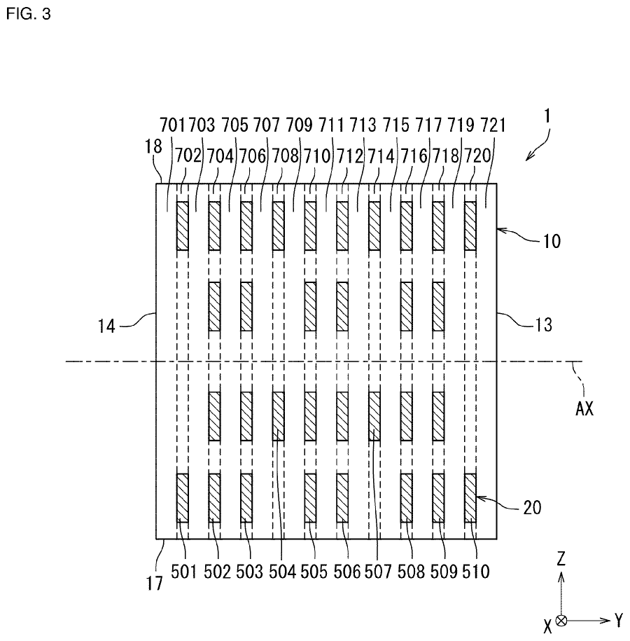

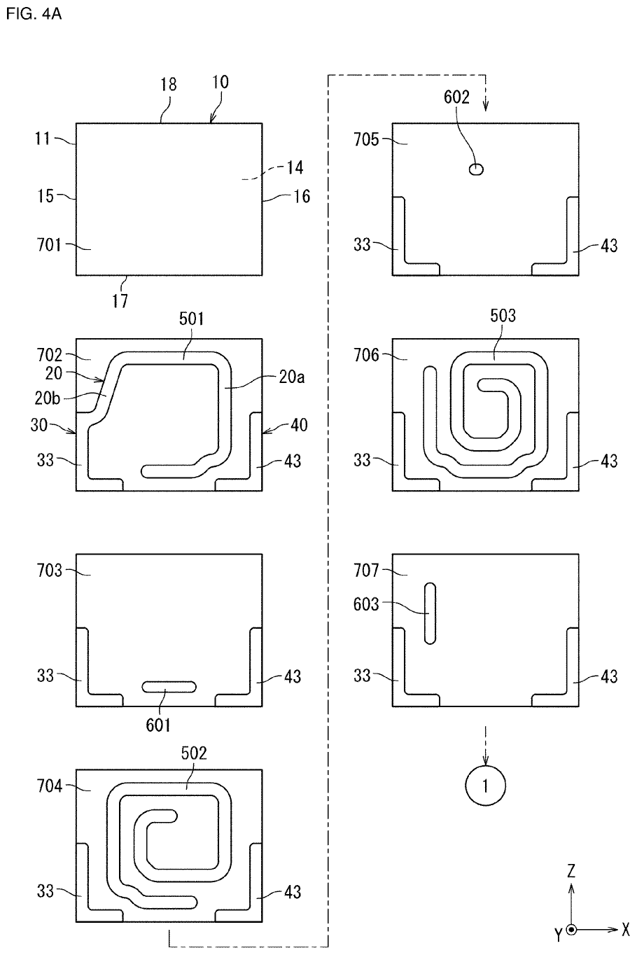

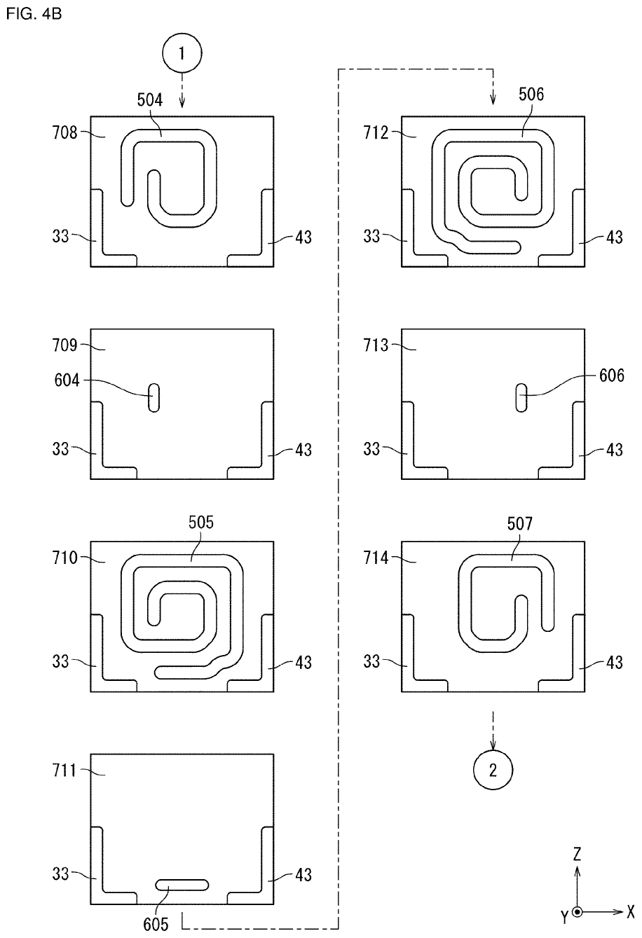

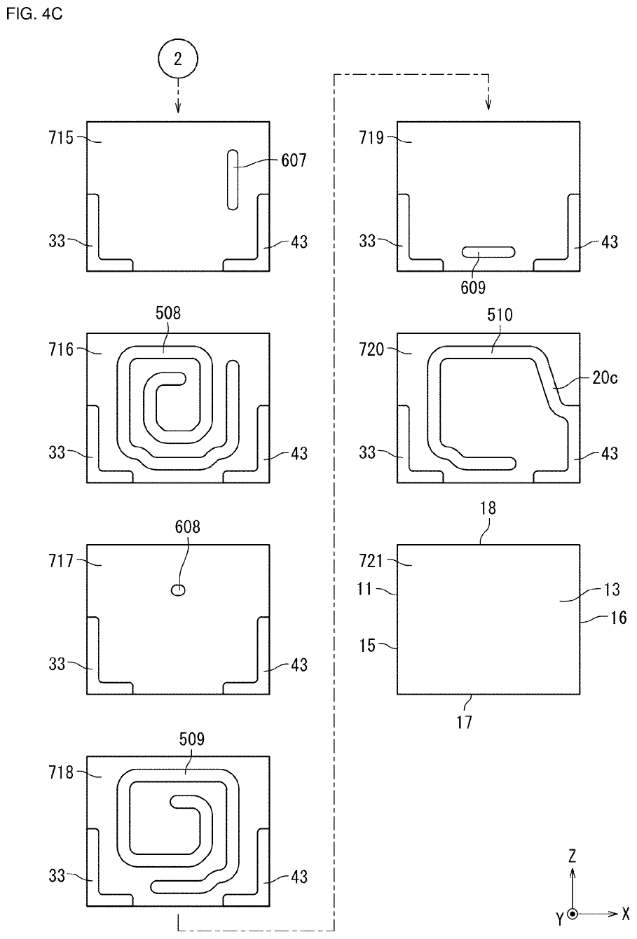

FIG. 1 is a perspective view of an inductor component according to a first embodiment. FIG. 2 is a perspective front view of an inductor component viewed from a first side surface. FIG. 3 is a YZ cross-sectional view of an inductor component. FIG. 4A, FIG. 4B, and FIG. 4C are exploded plan views of an inductor component. For convenience, FIG. 3 does not illustrate via wirings.

As illustrated in FIG. 1, FIG. 2, FIG. 3, FIG. 4A, FIG. 4B, and FIG. 4C, an inductor component 1 includes an element 10 including multiple insulating layers that are laminated, a coil 20 disposed in the element 10 and helically wound about an axis AX, and a first outer electrode 30 and a second outer electrode 40 disposed at the element 10 and electrically connected to the coil 20. For convenience, or for ease of understanding the structure, FIG. 2 illustrates the element and the coil as being transparent, but they may be semitransparent or opaque.

The inductor component 1 is electrically connected to wirings of a circuit board not illustrated, with the first and second outer electrodes 30 and 40 interposed therebetween. The inductor component 1 is used as, for example, an impedance matching coil (matching coil) for a high-frequency circuit, and included in an electronic device, such as a personal computer, a DVD player, a digital camera, a TV set, a mobile phone, automotive electronics, or a medical/industrial machine. The purpose of use of the inductor component 1 is not limited to this, and the inductor component 1 is also usable in, for example, a tuning circuit, a filter circuit, or a rectification smoothing circuit.

The element 10 has a substantially rectangular prism shape. The element 10 has a first end surface 15 and a second end surface 16 opposite to each other, a first side surface 13 and a second side surface 14 opposite to each other, a bottom surface 17 that connects the first end surface 15 and the second end surface 16 to each other, and the first side surface 13 and the second side surface 14 to each other, and a top surface 18 opposite to the bottom surface 17. When the inductor component 1 is mounted on a mount board not illustrated, the bottom surface 17 faces the mount board.

As illustrated, an X direction is a direction perpendicular to the first end surface 15 and the second end surface 16, directing from the first end surface 15 to the second end surface 16. A Y direction is a direction perpendicular to the first side surface 13 and the second side surface 14, directing from the second side surface 14 to the first side surface 13. A Z direction is a direction perpendicular to the bottom surface 17 and the top surface 18, directing from the bottom surface 17 to the top surface 18. The X direction is also referred to as a length direction of the element 10, the Y direction is also referred to as a width direction of the element 10, and the Z direction is also referred to as a height direction of the element 10. The X direction, the Y direction, and the Z direction are perpendicular to each other, and form a left-hand system when arranged in order of X, Y, and Z.

The element 10 is formed by sequentially laminating multiple insulating layers 701 to 721. The insulating layers 701 to 721 are formed from a material, such as, a material containing borosilicate glass as a main component, ferrite, or resin. The insulating layers are laminated in the direction parallel to the first and second end surfaces 15 and 16 and the bottom surface 17 of the element 10 (laminated in the Y direction). Specifically, the insulating layers 701 to 721 are layers expanding in the XZ plane. Herein, “parallel” is not limited to a parallel relationship in a strict sense, and includes a substantially parallel relationship in consideration of the range of actual variations. In the element 10, the interfaces between the multiple insulating layers 701 to 721 may be unclear due to, for example, firing.

The first outer electrode 30 and the second outer electrode 40 are formed from an electroconductive material such as Ag, Cu, Au, or an alloy containing any of these as a main component.

The first outer electrode 30 has an L shape extending from the first end surface 15 to the bottom surface 17. The first outer electrode 30 is embedded in the element 10 while being exposed from the first end surface 15 and the bottom surface 17. The first outer electrode 30 includes a first end surface portion 31 extending along the first end surface 15, and a first bottom surface portion 32 connected to the first end surface portion 31 and extending along the bottom surface 17.

The second outer electrode 40 has an L shape extending from the second end surface 16 to the bottom surface 17. The second outer electrode 40 is embedded in the element 10 while being exposed from the second end surface 16 and the bottom surface 17. The second outer electrode 40 includes a second end surface portion 41 extending along the second end surface 16, and a second bottom surface portion 42 connected to the second end surface portion 41 and extending along the bottom surface 17.

The first outer electrode 30 has a structure including multiple laminated first outer electrode conductor layers 33 embedded in the element 10 (first to twenty-first insulating layers 701 to 721). The second outer electrode 40 has a structure including multiple second outer electrode conductor layers 43 embedded in the element 10. The first outer electrode conductor layers 33 extend along the first end surface 15 and the bottom surface 17, and the second outer electrode conductor layers 43 extend along the second end surface 16 and the bottom surface 17.

The first and second outer electrodes 30 and 40 can thus be embedded in the element 10. Compared to the structure where outer electrodes are externally attached to the element 10, the inductor component can have a smaller size. In addition, the coil 20 and the outer electrodes 30 and 40 can be formed in the same process. When the in positional relationship between the coil 20 and the outer electrodes 30 and 40 has fewer variations, the electric characteristics of the inductor component 1 can have fewer variations.

The first outer electrode 30 may be formed from the first bottom surface portion 32 without including the first end surface portion 31. Similarly, the second outer electrode 40 may be formed from the second bottom surface portion 42 without including the second end surface portion 41. More specifically, the first outer electrode 30 and the second outer electrode 40 may be disposed on at least the bottom surface 17 of the element 10.

The coil 20 is formed from, for example, the same electroconductive material as the first and second outer electrodes 30 and 40. The coil 20 is helically wound about the direction in which the first to twenty-first insulating layers 701 to 721 are laminated. The first end of the coil 20 is connected to the first outer electrode 30, and the second end of the coil 20 is connected to the second outer electrode 40. In the present embodiment, the coil 20 and the first and second outer electrodes 30 and 40 are integrated without clear boundaries. Instead, the coil and the outer electrodes may be formed by different materials or different methods to have boundaries therebetween.

The coil 20 is wound about the axis AX that is parallel to the bottom surface 17, and that crosses the first side surface 13 and the second side surface 14. The axis AX of the coil 20 meets the direction in which the first to twenty-first insulating layers 701 to 721 are laminated (the Y direction). The axis AX of the coil 20 indicates the center axis of the helical shape of the coil 20. More specifically, the axis AX indicates the center of the innermost circumference of the coil 20.

The coil 20 includes a wound portion 20a, a first extended portion 20b that connects the first end of the wound portion 20a and the first outer electrode 30 to each other, and a second extended portion 20c that connects the second end of the wound portion 20a and the second outer electrode 40 to each other. In the present embodiment, the wound portion 20a and the first and second extended portions 20b and 20c are integrated without clear boundaries. Instead, the wound portion and the extended portions may be formed by different materials or different methods to have boundaries therebetween.

The wound portion 20a is helically wound about the axis AX. More specifically, the wound portion 20a indicates a helically wound portion where the portions of the coil 20 overlap when viewed in the direction parallel to the axis AX. The first and second extended portions 20b and 20c are portions deviating from the overlapping portions.

As illustrated in FIG. 2, FIG. 3, FIG. 4A, FIG. 4B, and FIG. 4C, the coil 20 includes multiple coil wiring layers 501 to 510 laminated along the axis AX, and first to ninth via wiring layers 601 to 609 extending along the axis AX to connect the coil wiring layers adjacent to each other in the direction of the axis AX. When viewed in the direction of the axis AX, the coil 20 has a shape of bilateral symmetry with respect to the straight line crossing the axis AX of the coil 20 and parallel to the Z direction. The inductor component 1 with this structure has fewer characteristic variations.

The multiple coil wiring layers 501 to 510 extend through the insulating layers 702, 704, 706, 708, 710, 712, 714, 716, 718, and 720 in the thickness direction (the Y direction). The coil wiring layers adjacent to each other in the lamination direction are electrically connected in series with the via wiring layers 601 to 609. Thus, the multiple coil wiring layers 501 to 510 form a helix while being electrically connected in series to each other. In the above embodiment, as illustrated in FIG. 4A, FIG. 4B, and FIG. 4C, the first to ninth via wiring layers 601 to 609 form a straight-line shape, but may have another shape such as a circular or arc shape. In FIG. 4A, FIG. 4B, and FIG. 4C, the direction from the upper left to the lower right is defined as a lamination direction (the Y direction).

More specifically, the first to tenth coil wiring layers 501 to 510 are sequentially laminated in the direction of the axis AX (the Y direction). The first to tenth coil wiring layers 501 to 510 are each wound along the corresponding plane. The end portion of the first coil wiring layer 501 is electrically connected to the first outer electrode conductor layers 33 of the first outer electrode 30. The end portion of the tenth coil wiring layer 510 is electrically connected to the second outer electrode conductor layers 43 of the second outer electrode 40.

The first outer electrode conductor layers 33 extend from the first end surface 15 to the bottom surface 17 across the second to twentieth insulating layers 702 to 720. The second outer electrode conductor layers 43 extend from the second end surface 16 to the bottom surface 17 across the second to twentieth insulating layers 702 to 720.

The first coil wiring layer 501 is located outermost on a first side in the direction of the axis AX (that is, the end closer to the second side surface 14), and is also referred to as a first outer coil wiring layer 501 below. The first outer coil wiring layer 501 includes a portion of the wound portion 20a and the first extended portion 20b. The first extended portion 20b is electrically connected to the first outer electrode conductor layers 33 of the first outer electrode 30. The tenth coil wiring layer 510 is located outermost on a second side in the direction of the axis AX (that is, the end closer to the first side surface 13), and is also referred to as a second outer coil wiring layer 510 below. The second outer coil wiring layer 510 includes a portion of the wound portion 20a and the second extended portion 20c. The second extended portion 20c is electrically connected to the second outer electrode conductor layers 43 of the second outer electrode 40.

The second coil wiring layer 502, the third coil wiring layer 503, the fourth coil wiring layer 504, the fifth coil wiring layer 505, the sixth coil wiring layer 506, the seventh coil wiring layer 507, the eighth coil wiring layer 508, and the ninth coil wiring layer 509 are located between the first outer coil wiring layer 501 and the second outer coil wiring layer 510, and are also referred to as the first inner coil wiring layer 502, the second inner coil wiring layer 503, the third inner coil wiring layer 504, the fourth inner coil wiring layer 505, the fifth inner coil wiring layer 506, the sixth inner coil wiring layer 507, the seventh inner coil wiring layer 508, and the eighth inner coil wiring layer 509 below.

As illustrated in FIG. 3, the first and second outer coil wiring layers 501 and 510 and the first to eighth inner coil wiring layers 502 to 509 have a uniform thickness. The first and second outer coil wiring layers 501 and 510 and the first to eighth inner coil wiring layers 502 to 509 may have a nonuniform thickness. For example, the thickness of the first and second outer coil wiring layers 501 and 510 may be greater than the thickness of the first to eighth inner coil wiring layers 502 to 509, or the thickness of the first and second outer coil wiring layers 501 and 510 may be smaller than the thickness of the first to eighth inner coil wiring layers 502 to 509. The first and second outer coil wiring layers 501 and 510 and the first to eighth inner coil wiring layers 502 to 509 may have different thicknesses.

The first and second outer coil wiring layers 501 and 510 have less than one turn. The first to eighth inner coil wiring layers 502 to 509 have one or more turns. The first and second outer coil wiring layers 501 and 510 may have one or more turns. The first to eighth inner coil wiring layers 502 to 509 may have less than one turn.

The first outer coil wiring layer 501, the first inner coil wiring layer 502, the second inner coil wiring layer 503, the third inner coil wiring layer 504, the fourth inner coil wiring layer 505, the fifth inner coil wiring layer 506, the sixth inner coil wiring layer 507, the seventh inner coil wiring layer 508, the eighth inner coil wiring layer 509, and the second outer coil wiring layer 510 are laminated while alternating with the first to twenty-first insulating layers 701 to 721.

More specifically, the first insulating layer 701 has the second side surface 14 of the element 10, and is in contact with the second insulating layer 702 on the surface opposite to the second side surface 14. The first outer coil wiring layer 501 is disposed on the second insulating layer 702 (the XZ plane) perpendicular to the direction of the axis AX, and is connected to the first outer electrode conductor layers 33. The third insulating layer 703 includes the first via wiring layer 601, and the first via wiring layer 601 is connected to the first outer coil wiring layer 501. The first inner coil wiring layer 502 is disposed on the fourth insulating layer 704 perpendicular to the direction of the axis AX, and is connected to the first via wiring layer 601. The fifth insulating layer 705 includes the second via wiring layer 602, and the second via wiring layer 602 is connected to the first inner coil wiring layer 502. The second inner coil wiring layer 503 is disposed on the sixth insulating layer 706 perpendicular to the direction of the axis AX, and is connected to the second via wiring layer 602. The seventh insulating layer 707 includes the third via wiring layer 603, and the third via wiring layer 603 is connected to the second inner coil wiring layer 503. The third inner coil wiring layer 504 is disposed on the eighth insulating layer 708 perpendicular to the direction of the axis AX, and is connected to the third via wiring layer 603. The ninth insulating layer 709 includes the fourth via wiring layer 604, and the fourth via wiring layer 604 is connected to the third inner coil wiring layer 504. The fourth inner coil wiring layer 505 is disposed on the tenth insulating layer 710 perpendicular to the direction of the axis AX, and is connected to the fourth via wiring layer 604. The eleventh insulating layer 711 includes the fifth via wiring layer 605, and the fifth via wiring layer 605 is connected to the fourth inner coil wiring layer 505. The fifth inner coil wiring layer 506 is disposed on the twelfth insulating layer 712 perpendicular to the direction of the axis AX, and is connected to the fifth via wiring layer 605. The thirteenth insulating layer 713 includes the sixth via wiring layer 606, and the sixth via wiring layer 606 is connected to the fifth inner coil wiring layer 506. The sixth inner coil wiring layer 507 is disposed on the fourteenth insulating layer 714 perpendicular to the direction of the axis AX, and is connected to the sixth via wiring layer 606. The fifteenth insulating layer 715 includes the seventh via wiring layer 607, and the seventh via wiring layer 607 is connected to the sixth inner coil wiring layer 507. The seventh inner coil wiring layer 508 is disposed on the sixteenth insulating layer 716 perpendicular to the direction of the axis AX, and is connected to the seventh via wiring layer 607. The seventeenth insulating layer 717 includes the eighth via wiring layer 608, and the eighth via wiring layer 608 is connected to the seventh inner coil wiring layer 508. The eighth inner coil wiring layer 509 is disposed on the eighteenth insulating layer 718 perpendicular to the direction of the axis AX, and is connected to the eighth via wiring layer 608. The nineteenth insulating layer 719 includes the ninth via wiring layer 609, and the ninth via wiring layer 609 is connected to the eighth inner coil wiring layer 509. The second outer coil wiring layer 510 is disposed on the twentieth insulating layer 720 perpendicular to the direction of the axis AX, and is connected to the ninth via wiring layer 609 at one end portion. The second outer coil wiring layer 510 is connected to the second outer electrode conductor layers 43 at another end portion. The twenty-first insulating layer 721 is in contact with the twentieth insulating layer 720, and has the first side surface 13 of the element 10 on the side opposite from the twentieth insulating layer 720.

The first to ninth via wiring layers 601 to 609 extend through the third, fifth, seventh, ninth, eleventh, thirteenth, fifteenth, seventeenth, and nineteenth insulating layers 703, 705, 707, 709, 711, 713, 715, 717, and 719 in the thickness direction (the Y direction). When viewed in the direction of the axis AX, the first to ninth via wiring layers 601 to 609 extend in the helical direction of the coil 20. The coil wiring layers adjacent to each other in the lamination direction are electrically connected in series with the via wiring layers interposed therebetween.

The first to twenty-first insulating layers 701 to 721 have a uniform thickness. The first to twenty-first insulating layers 701 to 721 may have nonuniform thicknesses. For example, the thickness of the first and twenty-first insulating layers 701 and 721 may be greater than the thickness of the second to twentieth insulating layers 702 to 720. Alternatively, for example, the thickness of the first and twenty-first insulating layers 701 and 721 may be smaller than the thickness of the second to twentieth insulating layers 702 to 720. The first to twenty-first insulating layers 701 to 721 may have different thicknesses.

The first via wiring layer 601, the second via wiring layer 602, the third via wiring layer 603, the fourth via wiring layer 604, the fifth via wiring layer 605, the sixth via wiring layer 606, the seventh via wiring layer 607, the eighth via wiring layer 608, and the ninth via wiring layer 609 are sequentially laminated in the Y direction. All the via wiring layers 601 to 609 have a straight-line shape. All the via wiring layers 601 to 609 have a uniform width throughout in the direction in which they extend.

The first via wiring layer 601 is located between the first outer coil wiring layer 501 and the first inner coil wiring layer 502 to connect the end portion of the first outer coil wiring layer 501 and the end portion of the first inner coil wiring layer 502 to each other. The second via wiring layer 602 is located between the first inner coil wiring layer 502 and the second inner coil wiring layer 503 to connect the end portion of the first inner coil wiring layer 502 and the end portion of the second inner coil wiring layer 503 to each other. The third via wiring layer 603 is located between the second inner coil wiring layer 503 and the third inner coil wiring layer 504 to connect the end portion of the second inner coil wiring layer 503 and the end portion of the third inner coil wiring layer 504 to each other. The fourth via wiring layer 604 is located between the third inner coil wiring layer 504 and the fourth inner coil wiring layer 505 to connect the end portion of the third inner coil wiring layer 504 and the end portion of the fourth inner coil wiring layer 505 to each other. The fifth via wiring layer 605 is located between the fourth inner coil wiring layer 505 and the fifth inner coil wiring layer 506 to connect the end portion of the fourth inner coil wiring layer 505 and the end portion of the fifth inner coil wiring layer 506 to each other.

The sixth via wiring layer 606 is located between the fifth inner coil wiring layer 506 and the sixth inner coil wiring layer 507 to connect the end portion of the fifth inner coil wiring layer 506 and the end portion of the sixth inner coil wiring layer 507 to each other. The seventh via wiring layer 607 is located between the sixth inner coil wiring layer 507 and the seventh inner coil wiring layer 508 to connect the end portion of the sixth inner coil wiring layer 507 and the end portion of the seventh inner coil wiring layer 508 to each other. The eighth via wiring layer 608 is located between the seventh inner coil wiring layer 508 and the eighth inner coil wiring layer 509 to connect the end portion of the seventh inner coil wiring layer 508 and the end portion of the eighth inner coil wiring layer 509 to each other. The ninth via wiring layer 609 is located between the eighth inner coil wiring layer 509 and the second outer coil wiring layer 510 to connect the end portion of the eighth inner coil wiring layer 509 and the end portion of the second outer coil wiring layer 510 to each other.

### Details of Coil Wiring Layer and Insulating Layer

In the inductor component 1, the thickness of the third insulating layer 703 between the first outer coil wiring layer 501 and the first inner coil wiring layer 502 adjacent to the first outer coil wiring layer 501 in the direction of the axis AX is smaller than or equal to 6.5 μm, and the Rdc of the first outer coil wiring layer 501 is smaller than or equal to 0.18Ω. Although not particularly limited, the thickness of the third insulating layer 703 may be, for example, greater than or equal to 3.5 μm. Although not particularly limited, the thickness of the third insulating layer 703 may be smaller than or equal to 3.5 μm. Although not particularly limited, the Rdc of the first outer coil wiring layer 501 may be greater than or equal to 0.09. The thickness of the insulating layer is the mean value of the dimension of the insulating layer measured in the direction parallel to the axis AX. The thickness of the insulating layer is obtained by exposing the two coil wiring layers that are in contact with the insulating layer of the measurement target by grinding in the direction parallel to the axis AX, and by measuring the mean distance between the two coil wiring layers. The Rdc of the first outer coil wiring layer 501 is the resistance value of the first outer coil wiring layer 501 in a cross section taken perpendicular to the axis AX of the coil 20. The Rdc is obtained by exposing the coil wiring layer (here, the first outer coil wiring layer 501) of a measurement target by grinding in the direction parallel to the XZ plane, and by measuring the Rdc of the first outer coil wiring layer 501 using, for example, a manual prober.

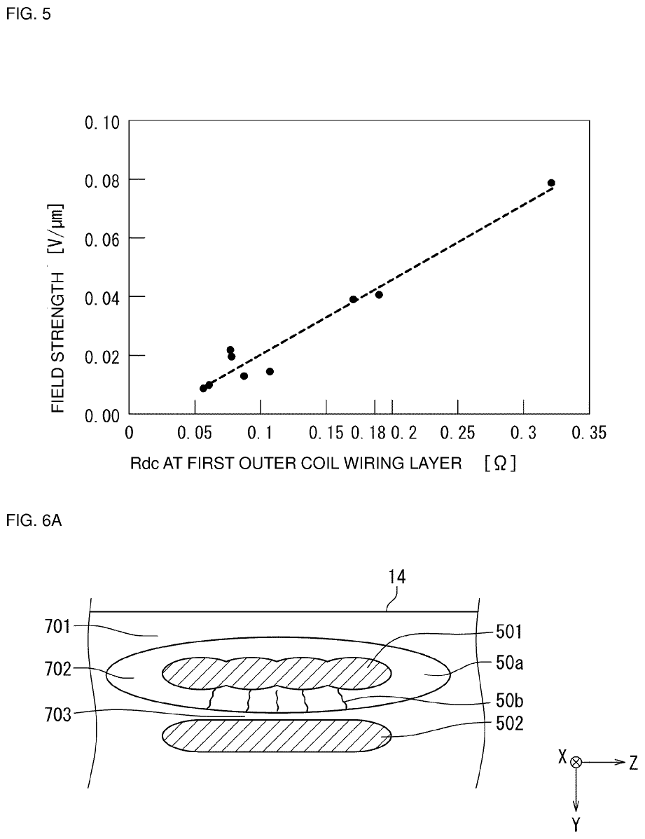

Description is provided more specifically with reference to FIG. 5. Hereafter, Ag is used as the material of the coil wiring layers 501 to 510, but a material other than Ag may also be used.

FIG. 5 is a graph with the horizontal axis indicating the Rdc [Ω] of the first outer coil wiring layer 501, and the vertical axis indicating the field strength [V/μm]. As illustrated in FIG. 5, when the Rdc of the first outer coil wiring layer 501 is smaller than or equal to 0.18Ω, the field strength between the first outer coil wiring layer 501 and the first inner coil wiring layer 502 is reduced regardless of when the thickness of the third insulating layer 703 between the first outer coil wiring layer 501 and the first inner coil wiring layer 502 is reduced. This structure leads to less occurrence of electrochemical migration between the first inner coil wiring layer 502 and the first outer coil wiring layer 501. In the present disclosure, electrochemical migration between the first inner coil wiring layer 502 and the first outer coil wiring layer 501 indicates a phenomenon where Ag in the first inner coil wiring layer 502 is ionized, and Ag+ travels to the first outer coil wiring layer 501, and is precipitated on the first outer coil wiring layer 501 as Ag. Normally, the strength E of the electric field is expressed with a formula E=V/d=R×I/d (wherein V denotes a voltage, d denotes the thickness of the insulating layer, R denotes resistance, and I denotes current). In the present disclosure, the field strength is defined as a value obtained when current I is twice the rated current, that is, as a value calculated based on the Rdc of the first outer coil wiring layer 501×(rated current×2)/the thickness of the insulating layer. The rated current is uniquely determined for the inductor component 1.

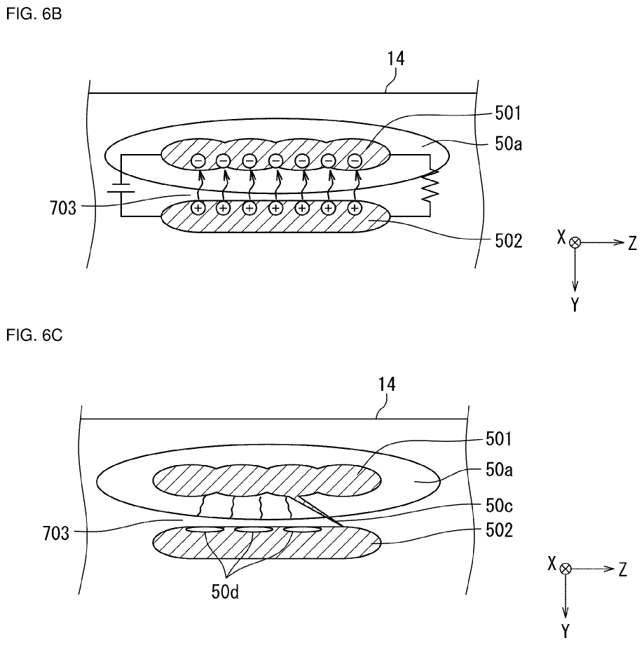

With reference to FIG. 6A, FIG. 6B, and FIG. 6C, a problem in an existing inductor component is described. FIG. 6A, FIG. 6B, and FIG. 6C are image diagrams of a portion of an existing inductor component in YZ cross section.

As illustrated in FIG. 6A, the first outer coil wiring layer 501 is disposed at the position closest to the second side surface 14, and then the third insulating layer 703, and the first inner coil wiring layer 502 are sequentially disposed. During sintering, the first outer coil wiring layer 501 closest to the second side surface 14 is excessively sintered. Thus, cracks are formed between particles forming the first outer coil wiring layer 501. The cracks isolate Ag, and the Ag is diffused among the first to third insulating layers 701 to 703 around the first outer coil wiring layer 501, and the first outer coil wiring layer 501 has an uneven surface (rounding of the first outer coil wiring layer 501). In other words, the volume of the first outer coil wiring layer 501 decreases, and the resistance of the first outer coil wiring layer 501 increases. In addition, diffusion of Ag around the first outer coil wiring layer 501 reduces the filler in the first to third insulating layers 701 to 703, and forms a low strength layer 50a having low strength. Stress occurs between the low strength layer 50a and the first outer coil wiring layer 501 due to the coefficient of linear expansion. The low strength layer 50a with low strength causes microcracks 50b.

As illustrated in FIG. 6B, when a voltage is applied to the inductor component 1, Ag in the first inner coil wiring layer 502 loses electrons, and Ag+ ions are reduced and precipitated. In the same mechanism as ion migration, the Ag+ ions travel to the first outer coil wiring layer 501, and Ag is precipitated at the first outer coil wiring layer 501.

As illustrated in FIG. 6C, when electrochemical migration in FIG. 6B occurs, cavities 50d are formed in the first inner coil wiring layer 502. The cavities 50d are portions where Ag was located before traveling to the first outer coil wiring layer 501. When the cavities 50d occur, a space is formed between the third insulating layer 703 and the first inner coil wiring layer 502. As illustrated in FIG. 6C, Ag precipitated at the first outer coil wiring layer 501 extends through the microcrack 50b from the first outer coil wiring layer 501 to the first inner coil wiring layer 502 to form a precipitated portion 50c. The precipitated portion 50c may cause a short circuit between the first outer coil wiring layer 501 and the first inner coil wiring layer 502.

In contrast, the inventors have found that, as illustrated in FIG. 5, reducing the Rdc of the first outer coil wiring layer 501 to smaller than or equal to 0.18Ω, the field strength can be reduced regardless of when the thickness of the third insulating layer 703 between the first outer coil wiring layer 501 and the first inner coil wiring layer 502 is reduced. This structure leads to less occurrence of electrochemical migration between the first inner coil wiring layer 502 and the first outer coil wiring layer 501. This structure also leads to fewer short circuits from electrochemical migration.

Preferably, the thickness of the nineteenth insulating layer 719 between the second outer coil wiring layer 510 and the eighth inner coil wiring layer 509 adjacent to the second outer coil wiring layer 510 in the direction of the axis AX is smaller than or equal to 6.5 μm, and the Rdc of the second outer coil wiring layer 510 is smaller than or equal to 0.18Ω. The above structure leads to less occurrence of electrochemical migration between the second outer coil wiring layer 510 and the eighth inner coil wiring layer 509.

Preferably, the line length of the first outer coil wiring layer 501 is smaller than or equal to 670 μm. When reducing the line length of the first outer coil wiring layer 501 reduces the Rdc, the field strength between the first outer coil wiring layer 501 and the first inner coil wiring layer 502 is reduced regardless of when the thickness of the third insulating layer 703 between the first outer coil wiring layer 501 and the first inner coil wiring layer 502 is reduced. Thus, the inductor component 1 leads to less occurrence of electrochemical migration between the first outer coil wiring layer 501 and the first inner coil wiring layer 502. The line length of the first outer coil wiring layer 501 is a dimension of the first outer coil wiring layer 501 in which it extends when viewed in the direction of the axis AX. More specifically, the line length is a dimension at the center line of the line width when viewed in the direction of the axis AX. As in the line length of the first outer coil wiring layer 501, the line length of the second outer coil wiring layer 510 may also be smaller than or equal to 670 μm. The line length of the second outer coil wiring layer 510 is a dimension of the second outer coil wiring layer 510 in which it extends when viewed in the direction of the axis AX.

Preferably, the ratio of the line length of the first outer coil wiring layer 501 to the cross-sectional area of the first outer coil wiring layer 501, that is, line length/cross-sectional area is smaller than or equal to 11 μm⁻¹. When the cross-sectional area of the first outer coil wiring layer 501 increases and the line length of the first outer coil wiring layer 501 decreases, the Rdc is reduced. Regardless of when the thickness of the third insulating layer 703 between the first outer coil wiring layer 501 and the first inner coil wiring layer 502 is reduced, the field strength between the first outer coil wiring layer 501 and the first inner coil wiring layer 502 is reduced. This structure leads to less occurrence of electrochemical migration between the first outer coil wiring layer 501 and the first inner coil wiring layer 502. The cross-sectional area of the first outer coil wiring layer 501 is the maximum cross-sectional area perpendicular to the direction in which the first outer coil wiring layer 501 extends when viewed in the direction of the axis AX. The ratio of the line length of the second outer coil wiring layer 510 to the cross-sectional area of the second outer coil wiring layer 510, that is, line length/cross-sectional area may be smaller than or equal to 11 μm⁻¹. The cross-sectional area of the second outer coil wiring layer 510 is the maximum cross-sectional area taken perpendicular to the direction in which the second outer coil wiring layer 510 extends when viewed in the direction of the axis AX.

Preferably, when a current twice the rated current is applied, the field strength between the first outer coil wiring layer 501 and the first inner coil wiring layer 502 adjacent to the first outer coil wiring layer 501 in the direction of the axis AX is smaller than or equal to 0.040 V/μm. Reducing the field strength leads to less occurrence of electrochemical migration between the first outer coil wiring layer 501 and the first inner coil wiring layer 502. The field strength between the second outer coil wiring layer 510 and the eighth inner coil wiring layer 509 adjacent to the second outer coil wiring layer 510 in the direction of the axis AX may be smaller than or equal to 0.040 V/μm.

Preferably, the first outer coil wiring layer 501 has less than one turn. The first outer coil wiring layer 501 with this structure can have smaller resistance. The second outer coil wiring layer 510 may have less than one turn.

Preferably, the first inner coil wiring layer 502 has one or more turns. The first inner coil wiring layer 502 with this structure can have improved inductance (L). The eighth inner coil wiring layer 509 may have one or more turns.

### Second Embodiment

As in the structure of the inductor component 1 according to the first embodiment, the structure of an inductor component 1A according to a second embodiment is illustrated in FIG. 1, FIG. 2, FIG. 3, FIG. 4A, FIG. 4B, and FIG. 4C. The components other than those described below are the same as the components of the inductor component 1 according to the first embodiment, and thus are not described.

In the second embodiment, regardless of the Rdc of the first outer coil wiring layer 501 according to the first embodiment, the line length of the first outer coil wiring layer 501 is smaller than or equal to 670 μm. The line length of the first outer coil wiring layer 501 is not particularly limited, but may be, for example, greater than or equal to 450 μm.

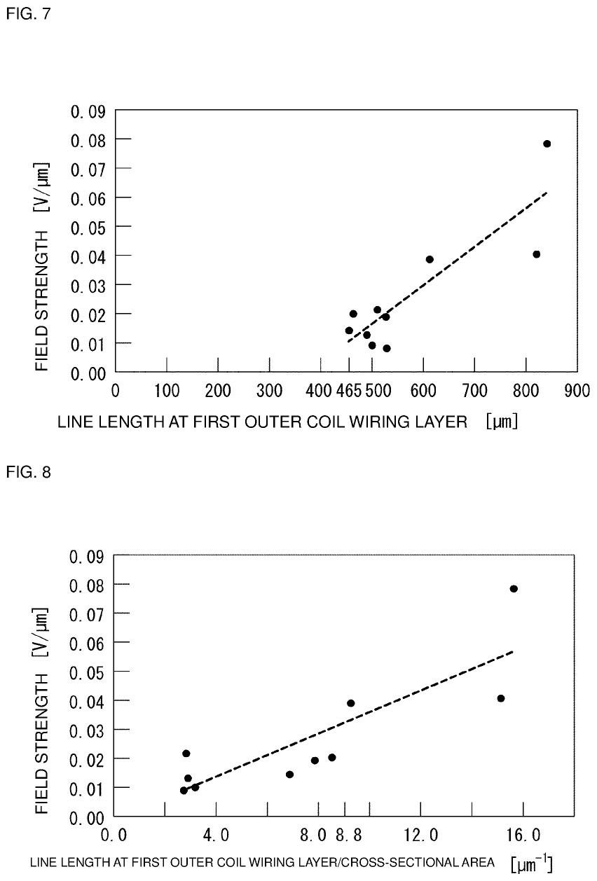

Detailed description is provided with reference to FIG. 7. FIG. 7 is a graph with the horizontal axis indicating the line length [μm] of the first outer coil wiring layer 501 and the vertical axis indicating the field strength [V/μm]. As illustrated in FIG. 7, when reducing the line length of the first outer coil wiring layer 501 reduces the Rdc, the field strength between the first outer coil wiring layer 501 and the first inner coil wiring layer 502 is reduced regardless of when the thickness of the third insulating layer 703 between the first outer coil wiring layer 501 and the first inner coil wiring layer 502 is reduced. Thus, the inductor component 1A leads to less occurrence of electrochemical migration between the first outer coil wiring layer 501 and the first inner coil wiring layer 502.

Preferably, the line length of the second outer coil wiring layer 510 is smaller than or equal to 670 μm. The line length of the second outer coil wiring layer 510 is not particularly limited, and may be, for example, greater than or equal to 450 μm. When reducing the line length reduces the Rdc, the field strength between the second outer coil wiring layer 510 and the eighth inner coil wiring layer 509 is reduced regardless of when the thickness of the nineteenth insulating layer 719 between the second outer coil wiring layer 510 and the eighth inner coil wiring layer 509 is reduced. Thus, the inductor component 1A leads to less occurrence of electrochemical migration between the second outer coil wiring layer 510 and the eighth inner coil wiring layer 509.

Preferably, the ratio of the line length of the first outer coil wiring layer 501 to the cross-sectional area of the first outer coil wiring layer 501, that is, line length/cross-sectional area is smaller than or equal to 11 μm⁻¹. The ratio of the line length of the second outer coil wiring layer 510 to the cross-sectional area of the second outer coil wiring layer 510, that is, line length/cross-sectional area may be smaller than or equal to 11 μm⁻¹.

Preferably, when a current twice the rated current is applied, the field strength between the first outer coil wiring layer 501 and the first inner coil wiring layer 502 adjacent to the first outer coil wiring layer 501 is smaller than or equal to 0.040 V/μm. The field strength between the second outer coil wiring layer 510 and the eighth inner coil wiring layer 509 adjacent to the second outer coil wiring layer 510 in the direction of the axis AX may be smaller than or equal to 0.040 V/μm.

Preferably, the first outer coil wiring layer 501 has less than one turn. The second outer coil wiring layer 510 may have less than one turn.

Preferably, the first inner coil wiring layer 502 has one or more turns. The eighth inner coil wiring layer 509 may have one or more turns.

### Third Embodiment

As in the structure of the inductor component 1 according to the first embodiment, the structure of an inductor component 1B according to a third embodiment is illustrated in FIG. 1, FIG. 2, FIG. 3, FIG. 4A, FIG. 4B, and FIG. 4C. The components other than those described below are the same as the components of the inductor component 1 according to the first embodiment, and thus are not described.

In the third embodiment, regardless of the Rdc of the first outer coil wiring layer 501 according to the first embodiment, the ratio of the line length of the first outer coil wiring layer 501 to the cross-sectional area of the first outer coil wiring layer 501, that is, line length/cross-sectional area is smaller than or equal to 11 μm⁻¹. When the first outer coil wiring layer 501 has a greater cross-sectional area, and a shorter line length, the Rdc is reduced. In other words, when the ratio of the line length of the first outer coil wiring layer to the cross-sectional area decreases, the Rdc is reduced, and the field strength between the first outer coil wiring layer 501 and the first inner coil wiring layer 502 is reduced regardless of when the thickness of the third insulating layer 703 between the first outer coil wiring layer 501 and the first inner coil wiring layer 502 is reduced. This structure leads to less occurrence of electrochemical migration between the first outer coil wiring layer 501 and the first inner coil wiring layer 502.

Detailed description is provided with reference to FIG. 8. FIG. 8 is a graph with the horizontal axis indicating the line length of the first outer coil wiring layer 501/cross-sectional area [μm⁻¹], and the vertical axis indicating the field strength between the first outer coil wiring layer 501 and the first inner coil wiring layer 502 [V/μm]. As illustrated in FIG. 8, when line length/cross-sectional area is smaller than or equal to 11 μm⁻¹, the Rdc is reduced, and the field strength between the first outer coil wiring layer 501 and the first inner coil wiring layer 502 is reduced.

Preferably, the ratio of the line length of the second outer coil wiring layer 510 to the cross-sectional area of the second outer coil wiring layer 510 is smaller than or equal to 11 μm⁻¹. When the second outer coil wiring layer 510 has a greater cross-sectional area and a shorter line length, the Rdc is reduced, and the field strength between the second outer coil wiring layer 510 and the eighth inner coil wiring layer 509 is reduced regardless of when the thickness of the nineteenth insulating layer 719 between the second outer coil wiring layer 510 and the eighth inner coil wiring layer 509 is reduced. This structure leads to less occurrence of electrochemical migration between the second outer coil wiring layer 510 and the eighth inner coil wiring layer 509.

Preferably, when a current twice the rated current is applied, the field strength between the first outer coil wiring layer 501 and the first inner coil wiring layer 502 adjacent to the first outer coil wiring layer 501 is smaller than or equal to 0.040 V/μm. The field strength between the second outer coil wiring layer 510 and the eighth inner coil wiring layer 509 adjacent to the second outer coil wiring layer 510 in the direction of the axis AX may be smaller than or equal to 0.040 V/μm.

Preferably, the first outer coil wiring layer 501 has less than one turn. The second outer coil wiring layer 510 may have less than one turn.

Preferably, the first inner coil wiring layer 502 has one or more turns. The eighth inner coil wiring layer 509 may have one or more turns.

### Fourth Embodiment

As in the structure of the inductor component 1 according to the first embodiment, the structure of an inductor component 1C according to a fourth embodiment is illustrated in FIG. 1, FIG. 2, FIG. 3, FIG. 4A, FIG. 4B, and FIG. 4C. The components other than those described below are the same as the components of the inductor component 1 according to the first embodiment, and thus are not described.

In the fourth embodiment, regardless of the Rdc of the first outer coil wiring layer 501 or the thickness of the third insulating layer 703 according to the first embodiment, the field strength between the first outer coil wiring layer 501 and the inner coil wiring layer 502 adjacent to the first outer coil wiring layer 501 in the direction of the axis AX is smaller than or equal to 0.040 V/μm. Reducing the field strength leads to less occurrence of electrochemical migration between the first outer coil wiring layer 501 and the first inner coil wiring layer 502.

Preferably, when a current twice the rated current is applied, the field strength between the second outer coil wiring layer 510 and the eighth inner coil wiring layer 509 adjacent to the second outer coil wiring layer 510 in the direction of the axis AX is smaller than or equal to 0.040 V/μm. Reducing the field strength leads to less occurrence of electrochemical migration between the second outer coil wiring layer 510 and the eighth inner coil wiring layer 509.

Preferably, the first outer coil wiring layer 501 has less than one turn. The second outer coil wiring layer 510 may have less than one turn.

Preferably, the first inner coil wiring layer 502 has one or more turns. The eighth inner coil wiring layer 509 may have one or more turns.

### Fifth Embodiment

As in the structure of the inductor component 1 according to the first embodiment, the structure of an inductor component 1D according to a fifth embodiment is illustrated in FIG. 1, FIG. 2, FIG. 3, FIG. 4A, FIG. 4B, and FIG. 4C. The components other than those described below are the same as the components of the inductor component 1 according to the first embodiment, and thus are not described.

In the fifth embodiment, regardless of the Rdc of the first outer coil wiring layer 501 or the thickness of the third insulating layer 703 according to the first embodiment, the first outer coil wiring layer 501 has less than one turn, and the first inner coil wiring layer 502 adjacent to the first outer coil wiring layer 501 in the direction of the axis AX has one or more turns. The first outer coil wiring layer 501 having less than one turn can have smaller resistance. The first inner coil wiring layer 502 having one or more turns can have improved inductance (L).

Preferably, the second outer coil wiring layer 510 has less than one turn, and the eighth inner coil wiring layer 509 adjacent to the second outer coil wiring layer 510 in the direction of the axis AX has one or more turns. The second outer coil wiring layer 510 having less than one turn can have smaller resistance. The eighth inner coil wiring layer 509 having one or more turns can have improved inductance.

### Sixth Embodiment

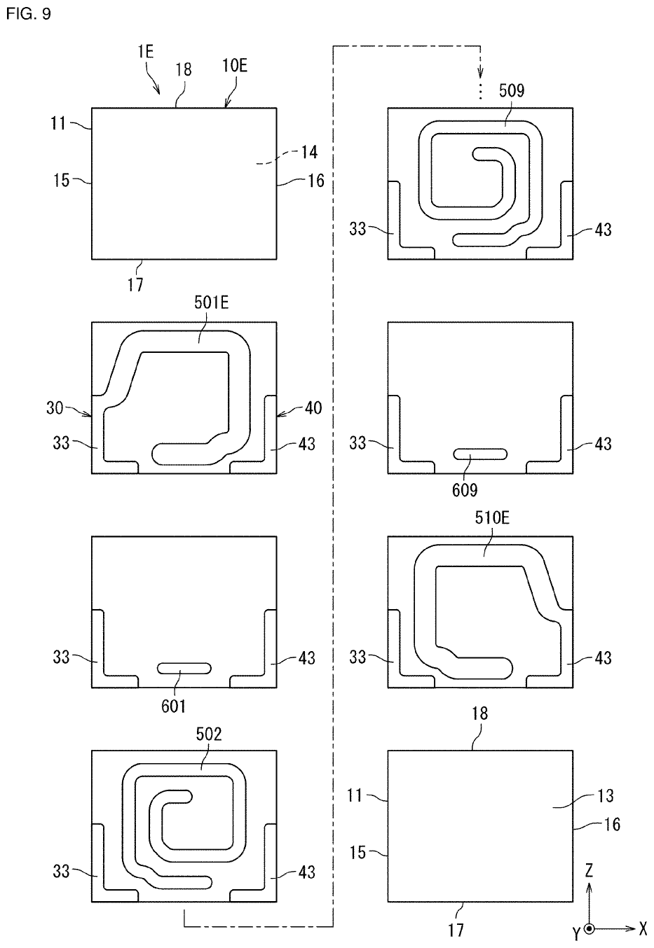

FIG. 9 is an exploded plan view of an inductor component 1E. The sixth embodiment differs from the first embodiment in the width of the coil wiring layer. Other components are the same as the components of the first embodiment, and thus are not described.

As illustrated in FIG. 9, in the inductor component 1E, the width of a first outer coil wiring layer 501E perpendicular to the direction in which the first outer coil wiring layer 501E extends and perpendicular to an axis of the first outer coil wiring layer 501E is greater than the width of the first inner coil wiring layer 502 adjacent to the first outer coil wiring layer 501E in the direction perpendicular to the direction in which an axis of the first inner coil wiring layer 502 extends. The inductor component 1E with the above structure reduces the Rdc of the first outer coil wiring layer 501E, and leads to less occurrence of electrochemical migration between the first outer coil wiring layer 501 and the first inner coil wiring layer 502. The width (line width) is a mean value of the width in the direction perpendicular to the axis AX of the coil 20.

Preferably, the width of a second outer coil wiring layer 510E in the direction perpendicular to the direction in which the axis AX of the second outer coil wiring layer 510E extends is greater than the width of the eighth inner coil wiring layer 509 in the direction perpendicular to the direction in which the axis of the eighth inner coil wiring layer 509 adjacent to the second outer coil wiring layer 510E extends.

### Seventh Embodiment

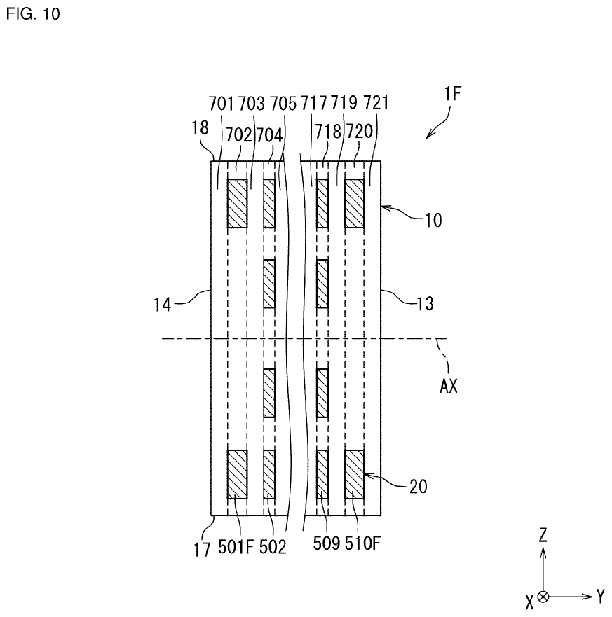

FIG. 10 is an exploded plan view of an inductor component 1F. The seventh embodiment differs from the first embodiment in the thickness of the first outer coil wiring layer. Other components are the same as those of the first embodiment, and thus are not described.

In the inductor component 1F, the thickness of the first outer coil wiring layer 501F in the direction parallel to the axis AX is greater than the thickness of the first inner coil wiring layer 502 in the direction parallel to the direction of the axis AX adjacent to the first outer coil wiring layer 501F in the direction of the axis AX. In the above structure, the Rdc of the first outer coil wiring layer 501F is reduced, and the field strength is reduced with application of a voltage.

Preferably, the thickness of the second outer coil wiring layer 510F in the direction parallel to the axis AX is greater than the thickness of the eighth inner coil wiring layer 509 in the direction parallel to the direction of the axis AX adjacent to the second outer coil wiring layer 510F in the direction of the axis AX. In the above structure, the Rdc of the second outer coil wiring layer 510F is reduced, and the field strength is reduced with application of a voltage.

The present disclosure is not limited to the above embodiments, and may be changed without departing from the gist of the present disclosure. For example, the features in the first to seventh embodiments may be combined in various manners. The shape of a core is not limited to the present embodiments, and may be changed. The quantity of coils is not limited to the embodiments, and may be changed.

The present disclosure includes the following aspects.
<1> An inductor component, comprising an element including a plurality of insulating layers that are laminated; and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and the first outer coil wiring layer has a direct current resistance smaller than or equal to 0.18Ω.
<2> The inductor component according to <1>, wherein the insulating layer between the second outer coil wiring layer and the inner coil wiring layer adjacent to the second outer coil wiring layer in the direction of the axis has a thickness smaller than or equal to 6.5 μm. Also, the second outer coil wiring layer has a direct current resistance smaller than or equal to 0.18Ω.
<3> An inductor component, comprising an element including a plurality of insulating layers that are laminated; and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and the first outer coil wiring layer has a line length smaller than or equal to 670 μm.
<4> The inductor component according to <3>, wherein the insulating layer between the second outer coil wiring layer and the inner coil wiring layer adjacent to the second outer coil wiring layer in the direction of the axis has a thickness smaller than or equal to 6.5 μm. Also, the second outer coil wiring layer has a line length smaller than or equal to 670 μm.
<5> An inductor component, comprising an element; and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The insulating layer between the first outer coil wiring layer and the inner coil wiring layer adjacent to the first outer coil wiring layer in the direction of the axis has a thickness smaller than or equal to 6.5 μm, and a ratio of a line length of the first outer coil wiring layer to a cross-sectional area of the first outer coil wiring layer is smaller than or equal to 11 μm⁻¹.
<6> The inductor component according to <5>, wherein the insulating layer between the second outer coil wiring layer and the inner coil wiring layer adjacent to the second outer coil wiring layer in the direction of the axis has a thickness smaller than or equal to 6.5 μm. A ratio of a line length of the second outer coil wiring layer to a cross-sectional area of the second outer coil wiring layer is smaller than or equal to 11 μm⁻¹.
<7> An inductor component, comprising an element; and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. When a current twice a rated current is applied, a field strength between the first outer coil wiring layer and the inner coil wiring layer adjacent to the first outer coil wiring layer in the direction of the axis is smaller than or equal to 0.040 V/μm.
<8> The inductor component according to <7>, wherein, when a current twice the rated current is applied, a field strength between the second outer coil wiring layer and the inner coil wiring layer adjacent to the second outer coil wiring layer in the direction of the axis is smaller than or equal to 0.040 V/μm.
<9> An inductor component, comprising an element; and a coil disposed in the element and helically wound about an axis. The coil includes a first outer coil wiring layer located outermost on a first side in a direction of the axis, a second outer coil wiring layer located outermost on a second side in the direction of the axis, and at least one inner coil wiring layer located between the first outer coil wiring layer and the second outer coil wiring layer. The first outer coil wiring layer, the at least one inner coil wiring layer, and the second outer coil wiring layer are laminated while alternating with the plurality of insulating layers. The first outer coil wiring layer has less than one turn, and the inner coil wiring layer adjacent to the first outer coil wiring layer in the direction of the axis has one or more turns.
<10> The inductor component according to <9>, wherein the second outer coil wiring layer has less than one turn, and the inner coil wiring layer adjacent to the second outer coil wiring layer in the direction of the axis has one or more turns.
<11> The inductor component according to any one of <1>, <2>, and <5> to <10>, wherein a line length of the first outer coil wiring layer is smaller than or equal to 670 μm.
<12> The inductor component according to any one of <1> to <4> and <7> to <10>, wherein a ratio of a line length of the first outer coil wiring layer to a cross-sectional area of the first outer coil wiring layer is smaller than or equal to 11 μm⁻¹.
<13> The inductor component according to any one of <1> to <6>, <9>, and <10>, wherein, when a current twice the rated current is applied, a field strength between the first outer coil wiring layer and the inner coil wiring layer adjacent to the first outer coil wiring layer is smaller than or equal to 0.040 V/μm.
<14> The inductor component according to any one of <1> to <8>, wherein the first outer coil wiring layer has less than one turn.
<15> The inductor component according to <14>, wherein the inner coil wiring layer adjacent to the first outer coil wiring layer has one or more turns.
<16> The inductor component according to any one of <1> to <15>, wherein a width of the first outer coil wiring layer perpendicular to a direction in which the first outer coil wiring layer extends and perpendicular to an axis of the first outer coil wiring layer is greater than a width of the inner coil wiring layer adjacent to the first outer coil wiring layer in a direction perpendicular to a direction in which an axis of the inner coil wiring layer extends.
<17> The inductor component according to any one of <1> to <15>, wherein a thickness of the first outer coil wiring layer in a direction parallel to the axis is greater than a thickness of the inner coil wiring layer adjacent to the first outer coil wiring layer in the direction of the axis, in a direction parallel the direction of the axis.

What is claimed is:

1. An inductor component, comprising:
an element including a plurality of insulating layers that are laminated; and
a coil in the element and helically wound about an axis,
wherein
the coil includes
a first outer coil wiring layer outermost on a first side in a direction of the axis,
a second outer coil wiring layer outermost on a second side in the direction of the axis, and
at least one inner coil wiring layer between the first outer coil wiring layer and the second outer coil wiring layer,
the first outer coil wiring layer, the at least one inner coil wiring layer, and the second outer coil wiring layer are laminated while alternating with the plurality of insulating layers,
the insulating layer between the first outer coil wiring layer and the inner coil wiring layer adjacent to the first outer coil wiring layer in the direction of the axis has a thickness smaller than or equal to 6.5 μm, and
the first outer coil wiring layer has a direct current resistance smaller than or equal to 0.18 Ω.

2. The inductor component according to claim 1, wherein
the insulating layer between the second outer coil wiring layer and the inner coil wiring layer adjacent to the second outer coil wiring layer in the direction of the axis has a thickness smaller than or equal to 6.5 μm, and
the second outer coil wiring layer has a direct current resistance smaller than or equal to 0.18Ω.

3. An inductor component, comprising:
an element including a plurality of insulating layers that are laminated; and
a coil in the element and helically wound about an axis,
wherein
the coil includes
a first outer coil wiring layer outermost on a first side in a direction of the axis,
a second outer coil wiring layer outermost on a second side in the direction of the axis, and
at least one inner coil wiring layer between the first outer coil wiring layer and the second outer coil wiring layer,
the first outer coil wiring layer, the at least one inner coil wiring layer, and the second outer coil wiring layer are laminated while alternating with the plurality of insulating layers,
the insulating layer between the first outer coil wiring layer and the inner coil wiring layer adjacent to the first outer coil wiring layer in the direction of the axis has a thickness smaller than or equal to 6.5 μm, and
the first outer coil wiring layer has a line length smaller than or equal to 670 μm.

4. The inductor component according to claim 3, wherein
the insulating layer between the second outer coil wiring layer and the inner coil wiring layer adjacent to the second outer coil wiring layer in the direction of the axis has a thickness smaller than or equal to 6.5 μm, and
the second outer coil wiring layer has a line length smaller than or equal to 670 μm.

5. An inductor component, comprising:
an element; and
a coil in the element and helically wound about an axis,
wherein
the coil includes
a first outer coil wiring layer outermost on a first side in a direction of the axis,
a second outer coil wiring layer outermost on a second side in the direction of the axis, and
at least one inner coil wiring layer between the first outer coil wiring layer and the second outer coil wiring layer,
the first outer coil wiring layer, the at least one inner coil wiring layer, and the second outer coil wiring layer are laminated while alternating with a plurality of insulating layers,
the insulating layer between the first outer coil wiring layer and the inner coil wiring layer adjacent to the first outer coil wiring layer in the direction of the axis has a thickness smaller than or equal to 6.5 μm, and
a ratio of a line length of the first outer coil wiring layer to a cross-sectional area of the first outer coil wiring layer is smaller than or equal to 11 μm⁻¹.

6. The inductor component according to claim 5, wherein
the insulating layer between the second outer coil wiring layer and the inner coil wiring layer adjacent to the second outer coil wiring layer in the direction of the axis has a thickness smaller than or equal to 6.5 μm, and
a ratio of a line length of the second outer coil wiring layer to a cross-sectional area of the second outer coil wiring layer is smaller than or equal to 11 μm⁻¹.

7. An inductor component, comprising:
an element; and
a coil in the element and helically wound about an axis,
wherein
the coil includes
a first outer coil wiring layer outermost on a first side in a direction of the axis,
a second outer coil wiring layer outermost on a second side in the direction of the axis, and
at least one inner coil wiring layer between the first outer coil wiring layer and the second outer coil wiring layer,
the first outer coil wiring layer, the at least one inner coil wiring layer, and the second outer coil wiring layer are laminated while alternating with a plurality of insulating layers, and
when a current twice a rated current is applied, a field strength between the first outer coil wiring layer and the inner coil wiring layer adjacent to the first outer coil wiring layer in the direction of the axis is smaller than or equal to 0.040 V/μm.

8. The inductor component according to claim 7, wherein
when a current twice the rated current is applied, a field strength between the second outer coil wiring layer and the inner coil wiring layer adjacent to the second outer coil wiring layer in the direction of the axis is smaller than or equal to 0.040 V/μm.

9. An inductor component, comprising:
an element; and
a coil in the element and helically wound about an axis,
wherein
the coil includes
a first outer coil wiring layer outermost on a first side in a direction of the axis,
a second outer coil wiring layer outermost on a second side in the direction of the axis, and
at least one inner coil wiring layer between the first outer coil wiring layer and the second outer coil wiring layer,
the first outer coil wiring layer, the at least one inner coil wiring layer, and the second outer coil wiring layer are laminated while alternating with a plurality of insulating layers,
the first outer coil wiring layer has less than one turn, and
the inner coil wiring layer adjacent to the first outer coil wiring layer in the direction of the axis has one or more turns.

10. The inductor component according to claim 9, wherein
the second outer coil wiring layer has less than one turn, and
the inner coil wiring layer adjacent to the second outer coil wiring layer in the direction of the axis has one or more turns.

11. The inductor component according to claim 1, wherein
a line length of the first outer coil wiring layer is smaller than or equal to 670 μm.

12. The inductor component according to claim 1, wherein
a ratio of a line length of the first outer coil wiring layer to a cross-sectional area of the first outer coil wiring layer is smaller than or equal to 11 μm⁻¹.

13. The inductor component according to claim 1, wherein
when a current twice a rated current is applied, a field strength between the first outer coil wiring layer and the inner coil wiring layer adjacent to the first outer coil wiring layer is smaller than or equal to 0.040 V/μm.

14. The inductor component according to claim 1, wherein
the first outer coil wiring layer has less than one turn.

15. The inductor component according to claim 14, wherein
the inner coil wiring layer adjacent to the first outer coil wiring layer has one or more turns.

16. The inductor component according to claim 1, wherein
a width of the first outer coil wiring layer perpendicular to a direction in which the first outer coil wiring layer extends and perpendicular to an axis of the first outer coil wiring layer is greater than a width of the inner coil wiring layer adjacent to the first outer coil wiring layer in a direction perpendicular to a direction in which an axis of the inner coil wiring layer extends.

17. The inductor component according to claim 1, wherein
a thickness of the first outer coil wiring layer in a direction parallel to the axis is greater than a thickness of the inner coil wiring layer adjacent to the first outer coil wiring layer in the direction of the axis, in a direction parallel the direction of the axis.

18. The inductor component according to claim 5, wherein
a line length of the first outer coil wiring layer is smaller than or equal to 670 μm.

19. The inductor component according to claim 3, wherein
a ratio of a line length of the first outer coil wiring layer to a cross-sectional area of the first outer coil wiring layer is smaller than or equal to 11 μm⁻¹.

20. The inductor component according to claim 3, wherein
when a current twice a rated current is applied, a field strength between the first outer coil wiring layer and the inner coil wiring layer adjacent to the first outer coil wiring layer is smaller than or equal to 0.040 V/μm.
